(19) United States
(12) Patent Application Publication
(10) Pub. No.: US 2024/0395433 A1
(43) Pub. Date: Nov. 28, 2024

(54) LIQUID TARGET SYSTEM

(71) Applicant: SCK.CEN, Brussel (BE)

(72) Inventors: Patrice JACQUET, Oleye (BE); Dominic MAERTENS, Dessel (BE); Willem LEYSEN, Geel (BE); Stephan HEINITZ, Mol (BE)

(21) Appl. No.: 18/691,567

(22) PCT Filed: Dec. 30, 2022
(86) PCT No.: PCT/EP2022/088084

§ 371 Date: Mar. 13, 2024

(30) Foreign Application Priority Data
Feb. 8, 2022 (EP) 22155720.0

(51) Int. Cl. G21G 1/04

(52) U.S. Cl. CPC G21G 1/04

(57) ABSTRACT

A liquid target system for the production of radio-isotopes, includes a boiling chamber for containing the liquid, being water or heavy water, and basic chemicals, being salts having a positive enthalpy for water, from which the radio-isotopes can be produced using irradiation, the boiling chamber comprising an irradiation window for allowing the liquid and basic chemicals to be irradiated, causing the liquid to evaporate into vapor, wherein the liquid target system is configured so that overheating of the liquid target is controlled by the thermodynamics of the evaporation process.

### TECHNICAL FIELD OF THE INVENTION

The present invention relates to the field of radio-isotopes. More specifically, the present invention relates to a liquid target system for the production of radio-isotopes, as well as to the use thereof and a corresponding method.

### BACKGROUND OF THE INVENTION

For the production of radio-isotopes, generally, solid targets are being used for their high yield in state-of-the-art systems, as for solid targets, a large density of a parent nuclide, from which the radio-isotopes, may be easily achieved. Indeed, a drawback of using a liquid targets is the limited solubility of most parent nuclide compounds in water (typically used as the liquid solvent) at room temperature. For example, salts of Ra-226, which may be used as basic chemicals for providing the parent nuclide for producing the radio-isotope Ra-225 that may decay to the radio-isotope Ac-225,have a limited solubility in water. By way of illustration, radium nitrate salt Ra(NO₃)₂ has a solibulity of 13.9 g per 100 g of H₂O at 20° C.

However, one advantage of using a liquid target rather than a solid target is that less (or no) liquid to solid and solid to liquid conversions are required in the chemical process for separating the radio-isotopes from the target. This chemical process step typically has a large risk on (uncontrolled) losses of radio-isotopes and radio-active waste generation. No such conversion is required for liquid targets, which is a huge advantage of such targets.

Furthermore, the potential disadvantage of a low parent nuclide concentration in liquid targets must be placed in perspective. As an example, the production of Ra-225 from Ra-226 via a photonuclear reaction is considered. The production of Ra-225 in function of time may depend on electron beam current (mA), electron energy (MeV), converter design and target design. Herein, the converter is designed for stopping the high energy electrons and producing high energy Bremsstrahlung photons that are needed for the photonuclear reaction. The more high energy photons that are produced, and the more Ra-226 directly in front of the photon beam, the more Ra-225 will be formed. However, assuming an electron-to-Bremsstrahlung photons conversion of about 50%, still about half of the energy of the electrons may be deposited into the converter. The very high energy deposition in the small converter volume associated therewith can easily limit the production capacity, hence reducing the yield of high energy Bremsstrahlung photons.

One way to deal with this is to have a plurality of thin slices of converter material separated by cooling means, and, in addition, to raster the electron beam over a larger surface area of the converter. However, the larger surface area will inevitable have a negative influence on the production rate. The consequence of a larger converter surface area is that Ra should be divided over the entire surface area where the high energy gammas are present, while the highest yields are obtained by positioning the Ra as close to the converter as possible. This can be considered a drawback for any kind of solid target, as the high density that can be achieved (e.g. 3-5 g/cc), cannot be optimally exploited when the current density of the converter is the limiting factor (e.g. 0.125-0.25 mA/cm²), and the surface to volume ratio needs to be increased.

US 2014/0362964 A1 describes an isotope production system configured to irradiate a starting liquid with a particle beam for generating radioisotopes and for transforming a portion of the starting liquid into vapor.

There are, therefore, a few drawbacks associated with solid targets. Nevertheless, the efficiency and yield of liquid targets is generally very low, so that in the state of the art, the focus remains on solid targets. There is, thus, still a need in the art for devices and methods that may improve the efficiency and the yield of liquid target systems.

### SUMMARY OF THE INVENTION

It is an object of the present invention to provide a good liquid target system. It is a further object of the present invention to provide a good method for producing radio-isotopes.

The above objective is accomplished by a method and apparatus according to the present invention.

It is an advantage of embodiments of the present invention that the yield and production of radio-isotopes may be comparable to that of a solid target. It is a further advantage of embodiments of the present invention that the amount of parent nuclide material needed for obtaining a certain amount of radio-isotopes is limited. It is still a further advantage of embodiments of the present invention that liquid targets are provided allowing production of radio-isotopes with low radio-active waste generation.

It is an advantage of embodiments of the present invention that the liquid target system may be continuously and efficiently cooled, thereby preventing overheating of the liquid target. It is a further advantage of embodiments of the present invention that the liquid target system allows for evacuating the heat in a steady-state, continuous and reliable way.

It is an advantage of embodiments of the present invention that the liquid target may have a large total volume, so that adverse effects expected from losses by, e.g., hydrogen formation or uncondensed water, may be limited. It is a further advantage of embodiments of the present invention that the liquid target system may be safe to operate. It is still a further advantage of embodiments of the present invention that operation of the liquid target can be monitored, e.g., by accurately tracking the temperature and/or pressure, which is often difficult for solid targets.

In a first aspect, the present invention relates to a liquid target system for the production of radio-isotopes. The liquid target system comprises a boiling chamber for containing the liquid and basic chemicals from which the radio-isotopes can be produced using irradiation. The boiling chamber comprises an irradiation window for allowing the liquid and basic chemicals to be irradiated, causing the liquid to evaporate into vapor. The liquid target system is configured so that overheating of the liquid target is controlled by the thermodynamics of the evaporation process.

Where in embodiments of the present invention reference is made to an irradiation window, reference is made to an area in the wall of the boiling chamber that allows the radiation required for irradiating the basic chemicals from which the radio isotopes can be produced to enter the boiling chamber. The type of irradiation window that is used may depend on the type of irradiation. For example, in the case of the use of gamma radiation, the wall may for example be transparent for the radiation anyway.

In embodiments, the liquid target system being configured so that overheating of the liquid target is controlled by the thermodynamics of the evaporation process, may comprise that the liquid target system is configured to use evaporation of the liquid for preventing said overheating, preferably for controlling the temperature of the liquid target. Overheating of the liquid target may result in evaporation of substantially all liquid in the liquid target, so that the basic chemicals are boiled to dryness.

It is an advantage of embodiments of the present invention that, as overheating of the liquid target may be prevented, the liquid target system allows to avoid release of non-condensable gasses from the chemical materials, allows for avoiding sintering of the chemical materials and/or allows for avoiding formation of insoluble chemical materials. Said overheating may occur as a result of the large amount of irradiation energy deposited in the liquid target. In particular, the so-called pair production reaction contributes to heating up of the liquid target. In the pair production reaction, a high energy photon in the presence of a high Z nucleus (e.g., a parent nuclide Ra-226) is converted to an electron and a positron with remaining kinetic energy. As the charged particles, i.e., the electron and the positron, slow down (and anneal in the case of the positron), they will release their kinetic energy inside the liquid target, which is transferred into heat.

It is an advantage of embodiments of the present invention that a cooling circuit for the liquid target system, controlled by pumps, wherein the liquid and basic chemicals are pumped in the cooling circuit, may not be required. It is a further advantage of embodiments of the present invention that large heat exchangers requiring a large contact area with the liquid target may be avoided, so that the amount of liquid target that is required can be limited.

It is an advantage of embodiments of the present invention that the system allows for up-concentrating during operation. More particularly, whereas the initial concentration of the basic chemicals used for producing radio-isotopes in the liquid at the starting temperature may be limited due to the solubility in the solvent, e.g. water, and higher concentrations at this starting temperature would result in precipitation, it is an advantage of embodiments of the present invention that the concentration can be increased during heating up of the liquid target, in line with the increase of the solubility of the basic chemicals in the solvent, e.g. water. The later is established by evaporation of the solvent, whereas the basic chemicals are maintained in the irradiated area.

In embodiments, the evaporated water may be stored in the system as steam or as liquid.

In embodiments, the liquid target system further comprises a condensation area positioned above the boiling chamber, the condensation area having walls for condensing the liquid vapour into liquid condensate, wherein the liquid condensate can be systematically returned or provided to the boiling chamber. Such walls also may be referred to as cooling surfaces. In embodiments, the liquid target system is configured for systematically returning the liquid condensate into the boiling chamber, e.g., by a direct fluidic connection between the condensation area and the boiling chamber, or by dropping of liquid condensate from the condensation area (e.g., due to gravity) systematically into the boiling chamber.

In embodiments, the at least one condensate collecting area thus may be positioned at the walls for condensing the vapor and may be provided with a dripping mechanism for systematically returning the condensate to the boiling chamber.

In preferred embodiments, the liquid target system further comprises at least one condensate collecting area for collecting the liquid condensate, the at least one condensate collecting area being positioned outside the boiling chamber (i.e., the at least one condensate collecting area and the boiling chamber are separated from each other), wherein the at least one condensate collecting area and the boiling chamber are interconnected so as to act as communicating vessels. In embodiments, the at least one condensate collecting area and the boiling room are configured such that a ratio of a volume of the liquid condensate, i.e., the liquid, present in the at least one liquid condensate collecting area to a volume of the liquid present in the boiling chamber is at least 0.5,preferably at least 1, more preferable at least 2. In embodiments, a ratio of an area of a horizontal cross-section of the at least one condensate collecting area to an area of a horizontal cross-section of the boiling chamber is at least 0.5, preferably at least 1, more preferably at least 2. The dimensions of the system may be selected so as to obtain an up-concentration to a factor 2. It is an advantage of these embodiments that, as the basic chemicals may become concentrated in the boiling chamber, and may be absent in the at least one condensate collecting area, during functioning of the liquid target system, up-concentration of the basic chemicals in the boiling chamber is possible that reaches at least 50%, preferably at least 100%, preferably at least 200%, higher than an initial concentration of the basic chemicals when present in all liquid, including in any liquid present in the at least one condensate collecting area.

In embodiments, the volume of the boiling chamber is from 5 mL to 500 mL. In embodiments, the total volume of the at least one condensate collecting area is from 5 mL to 500 mL.

In embodiments, said interconnection between the boiling chamber and the at least one condensate collecting area comprises a gap or a tubing. In embodiments, an inlet of the interconnection for letting liquid into the boiling chamber is located near a bottom of the boiling chamber, e.g., in a wall or in the bottom. Preferably, said inlet is located at a height in the boiling chamber below 25% of the height of the boiling chamber, preferably below 10% of the height of the boiling chamber, more preferably substantially at the bottom of the boiling chamber. In embodiments, a cross-sectional area of said interconnection, perpendicular to the nominal flow direction within said interconnection, is at most 10%, preferably at most 5%, more preferably at most 2%, of at least one, e.g., both, of a vertical or horizontal cross-sectional area of the boiling chamber.

By way of illustration, embodiments not being limited thereto, an example is discussed below. For a target that receives for example 1200 W, with 50% of energy effectively used to convert liquid to steam, and a single opening of 0.2 cm² (corresponding to a radius of about 2.5 mm in a circular opening), the liquid would travel at a velocity of 1.33 cm/s. The smaller the opening, the larger the veloity will be. By using a small section for the interconnection, counter flow is avoided from the irradiation chamber towards the condensate chamber. By selecting the section small enough, the liquid is flowing uniformly in one direction with a sufficiently high velocity. The length and/or diameter of the interconnection can be designed to create a pressure drop that will create a liquid level difference. In some embodiments, the design is made so as to store the condensate above the irradiation chamber irradiation level. This ensures that most of the condensate will return to the irradiation chamber when the irradiation and thus the boiling tops. In this way the chemicals are diluted and precipitation is avoided when the solution cools down.

In alternative examples, the inlet may be positioned at the top of the system and operate via drips.

It is an advantage of these embodiments that heat dissipation in the liquid target system (and hence prevention of overheating) is guaranteed by the boiling and condensing process of the liquid. The condensation area may be cooled by a secondary system that contains a cooling fluid not containing radioactive material. In embodiments, the liquid target system further comprises a coolant fluid bath and/or a coolant fluid circulation secondary system for cooling the condensation area. In preferred embodiments, the condensation area and the at least one condensate collecting area is at least partly surrounded by the coolant fluid circulation secondary system.

It is an advantage of embodiments of the present invention that the liquid target system may automatically act as a concentrator, so that the concentration of basic chemicals may be increased in the irradiated volume during the heating process, and the subsequent liquid evaporation, caused by the irradiation. Furthermore, as the solubility of the basic chemicals in the liquid typically increases with temperature, the liquid target may contain a high concentration of basic chemicals, without precipitating, allowing efficient production of the radio-isotopes. Indeed, since the solubility of the basic chemical materials from which the radio-isotopes are generated is relatively low at room temperature, it is an advantage that the concentration may be increased during the heating process caused by the irradiation, taking advantage of the higher solubility of the basic chemical materials in the liquid at higher temperature.

In embodiments, the system further comprises an irradiation beam generator configured for irradiating the liquid and basic chemicals. Herein, the irradiation beam generator is typically located outside of the boiling chamber, and is configured for irradiating the liquid and basic chemicals through the irradiation window. In embodiments, the irradiation beam generator is selected from: an electron beam gun; a gamma beam gun; a proton beam gun; and a neutron beam gun. In embodiments comprising the electron beam gun or the proton beam gun, the irradiation beam generator may further comprise a converter for converting a charged particle beam (i.e., electron beam or proton beam) into high energy Bremsstrahlung photons, which form the irradiation beam.

In embodiments comprising the at least one condensate collecting area, the irradiation beam generator may be configured such that the irradiation beam propagates from the irradiation beam generator located outside of the boiling chamber, through the irradiation window, into the boiling chamber, without passing through the at least one condensate collecting area. It is an advantage of embodiments of the present invention that any liquid in the at least one condensate collecting area is not boiled, thereby transforming liquid in the at least one condensate collecting area into vapor. This may result in up-concentration of the basic chemicals present in the at least one condensate collecting area, which may result in a reduction in concentration of the basic chemicals in the boiling chamber. It is a further advantage of these embodiments that the irradiation beam may not be attenuated by absorption by the liquid condensate in the at least one condensate collecting area.

In embodiments, the liquid target system comprises a pressurizing unit for pressuring the system for controlling the bubble size and the boiling temperature of the liquid. In these embodiments, the system may further comprise a pressure sensor for measuring the pressure of the boiling chamber or system.

In embodiments, the boiling chamber, the condensation area and the at least one condensate collecting area form a system having a cylindrical design. It is an advantage of embodiments of the present invention that the number of welds in a cylindrical design is typically limited, which may render the system pressure proof.

In embodiments, the boiling chamber comprises an inlet and outlet for generating a flow of an inert gas, e.g., argon, helium or nitrogen, preferably helium, though the boiling chamber. The loss of uncondensed water (humidity) leaving the liquid target system at the same flow rate as the inert gas, could be compensated by exposing the inert gas to water (humidity) prior to adding it to the target system. This way the mass balance of water can be kept as a constant (with the exception of hydrogen gas leaving the system).

It is an advantage of these embodiments that good pressure control may be achieved. It is a further advantage that the inert gas flow may be used to remove any gaseous material formed in the boiling chamber out of the boiling chamber, for collecting said gaseous material (e.g., Rn when the parent nuclide comprises Ra-226). In embodiments, the boiling chamber comprises an inlet for introducing and/or removing the liquid target, i.e., the liquid and basic chemicals, from the boiling chamber.

In embodiments, the basic chemicals comprises, or consists of, a salt comprising a radionuclide for forming the radio-isotopes when exposed to the irradiation. Said radionuclide is typically a cation, and the salt further comprises an anion. In embodiments, the liquid is water or heavy water and the basic chemicals are salts having a positive enthalpy for water. In embodiments, the basic chemicals are any or a combination of Ra(NO₃)₂, RaCl₂, and Ba(NO₃)₂. It is to be noted that whereas in embodiments of the present invention reference is often made to production of Ac-225, embodiments are not limited thereto and liquid target systems for production of other isotopes are also envisaged. It is an advantage of embodiments of the present invention that these salts have sufficient solubility in water. In embodiments, the salt comprises one of: a Ca salt, which may be used for Sc-47 production; a Zn salt, which may be used for Cu-67production; a Ba salt, which may be used for Cs-131 production; and Dy salt, which may be used for Tb-155 production. In embodiments, the liquid target system is adapted for producing Sc-47,Cu-67, Cs-131, Tb-155, Ra-225, or Ac-225, preferably Ac-225.

Any features of any embodiment of the first aspect may be independently as correspondingly described for any embodiment of any of the other aspects of the present invention.

In a second aspect, the present invention relates to a method for producing radio-isotopes. The method comprises irradiating a liquid target comprising the liquid and basic chemicals from which the radio-isotopes can be produced using irradiation, causing the liquid to evaporate into vapor. Herein, the thermodynamics of said evaporation process are used so as to control overheating of the liquid target.

In embodiments, the method may be performed using a liquid target system in accordance with embodiments of the first aspect of the present invention.

In embodiments, the method comprises a step, after said irradiating, of collecting the radio-isotopes from the liquid target.

In embodiments, said irradiating is performed using a power incident on the liquid target of for example 1.5 kW, for example of a power between 0.5 kW and 10 KW, e.g. between 0.5 kW and 5 KW, e.g. between 0.5 kW and 3 kW. In embodiments, the step of irradiating is performed at a pressure of between vacuum and 60 bar, e.g. between 0.5 bar and 10 bar. It is to be noted that in principle also higher pressures can be used.

In preferred embodiments, the liquid target has a concentration of basic chemicals, e.g., at the location of irradiation, during at least part said irradiating, that is higher than a solubility, i.e., maximum concentration before precipitation occurs, of the basic chemicals in the liquid at a temperature of 25° C. and a pressure of 1 atm, preferably at least 20% higher, more preferably at least 50% higher, even more preferably at least 100% higher, yet more preferably at least 200% higher. Typically, the maximum concentration that may be achieved is equal to the solubility of the basic chemicals, as any further basic chemicals would not dissolve in the liquid, e.g., precipitate from the liquid.

Any features of any embodiment of the second aspect may be independently as correspondingly described for any embodiment of any of the other aspects of the present invention.

In a third aspect, the present invention relates to a use of the liquid target system according to embodiments of the first aspect for producing radio-isotopes.

Any features of any embodiment of the third aspect may be independently as correspondingly described for any embodiment of any of the other aspects of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1A is a schematic exploded view of at least part of a liquid target system in accordance with embodiments of the present invention.

FIG. 1B is a schematic vertical cross-section of at least part of the liquid target system of FIG. 1A that is in accordance with embodiments of the present invention.

FIG. 2 is a a plot of the solubility, in grams of the salt per 100mL of H₂O, as dependent on temperature, in degrees Celsius, for Ba(NO₃)₂ and Ra(NO₃)₂.

FIG. 3 is a diagrammatic illustration of a liquid target system in accordance with embodiments of the present invention.

FIG. 4 is a schematic vertical cross-section a liquid target system in accordance with embodiments of the present invention.

FIG. 5 is a schematic vertical cross-section the liquid target system of FIG. 4, after heating of the liquid target by irradiation of said liquid target.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, cither temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. The term “comprising” therefore covers the situation where only the stated features are present and the situation where these features and one or more other features are present. The word “comprising” according to the invention therefore also includes as one embodiment that no further components are present. Thus, the scope of the expression “a device comprising means A and B” should not be interpreted as being limited to devices consisting only of components A and B. It means that with respect to the present invention, the only relevant components of the device are A and B.

Similarly, it is to be noticed that the term “coupled” should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

In a first aspect, the present invention relates to a liquid target system for the production of radio-isotopes. The liquid target system comprises a boiling chamber for containing the liquid and basic chemicals from which the radio-isotopes can be produced using irradiation. The boiling chamber comprises an irradiation window for allowing the liquid and basic chemicals to be irradiated, causing the liquid to evaporate into vapor. The liquid target system is configured so that overheating of the liquid target is controlled by the thermodynamics of the evaporation/condensation process.

In a second aspect, the present invention relates to a method for producing radio-isotopes. The method comprises irradiating a liquid target comprising the liquid and basic chemicals from which the radio-isotopes can be produced using irradiation, causing the liquid to evaporate into vapor. Herein, the thermodynamics of said evaporation process are used so as to control overheating of the liquid target.

In a third aspect, the present invention relates to a use of the liquid target system according to embodiments of the first aspect for producing radio-isotopes.

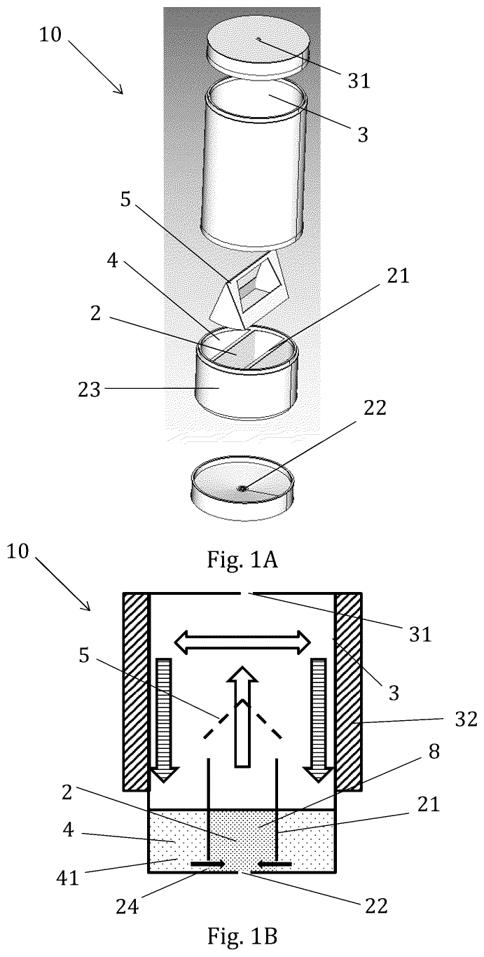

Reference is made to FIG. 1A, which is a schematic exploded view of at least part of a liquid target system 10 in accordance with embodiments of the present invention. Simultaneously, reference is made to FIG. 1B, which is a schematic vertical cross-sectional view of said at least part of the liquid target system 10. In this example, the liquid target system, that is for the production of radio-isotopes, comprises a boiling chamber 2 for containing a liquid target 8, that consists of a liquid and basic chemicals from which radio-isotopes can be produced using irradiation. An irradiation window 23, that is in this example part of a wall of the boiling chamber 2, through which said irradiation may propagate, is comprised in a wall of the boiling chamber 2. In this example, the liquid comprised in the liquid target 8 in the boiling chamber 2 is water, and the basic chemicals dissolved in the water is a salt comprising parent nuclide Ra-226, e.g., (Ra-226)(NO₃)₂, although the invention is not limited thereto. As such, in this example, the liquid target 8 consists of the liquid and the salt comprising Ra-226.

The liquid target 8 is continuously irradiated by a high energy photon beam through the irradiation window 23. As a result, the liquid target 8 will boil under said continuous irradiation, thereby transforming the liquid into vapor, i.e., water vapor (white arrows). The water vapor is, subsequently, condensed in a condensation area 3 located above the boiling chamber 2, thereby transforming the vapor into liquid condensate. At least the condensation area 3, but possibly also the condensate collection area 4, and possible also the boiling chamber 2, may be cooled by a water coolant fluid bath and/or a forced coolant fluid water circulation secondary system 32.

In this example, the liquid target system further comprises two condensate collecting areas 4, different from the boiling chamber 2 and, in this example, separated from each other by separation walls 21. The two condensate collecting areas 4 are located on opposite sides of the boiling chamber 2, each time separated by the separation walls 21. The liquid target system is configured so that condensate formed in the condensation area 3 moves, e.g., drops, into the condensate collecting areas 4 (arrows filled with horizontal stripes). This is, in this example, achieved as walls of the condensate collecting areas 4 are connected to walls of the condensation area 3, such that liquid condensed on the walls of the condensation area 3 may move, e.g., downwards over said wall, into the condensate collecting areas 4. Furthermore, in this example, the liquid target system comprises a condensate steering element 5, that steers any condensate, away from the boiling chamber, to the condensate collection areas 4 (which may otherwise be called condensate collection chambers).

The condensate collecting areas 4 are fluidically coupled to the boiling chamber 2, e.g., via openings 24 in the separation walls 21. For example, as in this example, at least a portion of the separation walls 21 may be separated from a bottom of the boiling chamber 2 by a gap 24, through which the liquid may move between the condensate collecting areas 4 and the boiling chamber 2. Alternatively, e.g., tubing may be used to implement said fluidic coupling. Thereby, liquid condensate 41 collected in the condensate collecting areas 4 may flow into the boiling chamber 2 (black arrows).

As such, the condensate collecting areas 4 and the boiling chamber 2 may be considered as functioning as, in this example, three communicating vessels, wherein the liquid target 8 in the boiling chamber 2 is boiling, being directly positioned in the high energy photon beam, while the condensate is collected in the condensate collecting areas 4, which is not boiling due to the lower energy deposition into the condensate collecting areas 4. Indeed, the condensate, i.e., liquid, in the condensate collecting areas 4 may not comprise Ra-226 in significant quantities for absorbing the irradiation, due to a continuous effective liquid flow (black arrows) from the condensate collecting areas 4, through the gap, to the boiling chamber 2, which compensates a flow of vapor (white arrows) and a flow of condensate (arrows with horizontal stripes) via the condensation area 3. In a steady state, the rates of each of these three flows may be substantially equal. The condensate 41 will be at a significantly lower irradiation level. Furthermore due to the absence of Ra, there is a lower heat absorption causing the condensate not to boil. In other words, as the condensate collecting areas 4 and the boiling chamber 2 are essentially communicating vessels, the continuous loss of water mass in the boiling chamber 2 due to said boiling will be compensated by a continuous flow of water from the condensate collecting areas 4, through the hole at the bottom of the target, into the boiling chamber 2. The size of the gap (or, alternative, a diameter of the tubing) is preferably optimized in a way such that there is a continuous flow of condensate, i.e., liquid, towards the boiling chamber 2, so that substantially no Ra-226 moves in the opposite direction, i.e., from the boiling chamber 2, towards and into the condensate collecting areas 4. The opening should therefore be not be too narrow, and not too large. Preferably, a liquid flow rate through the opening, towards the boiling chamber is from 0.1 cm/s to 20 cm/s, preferably from 0.5 cm/s to 5cm/s, for example, 1 cm/s. Preferably, said liquid flow rate substantially completely results from the loss of liquid in the boiling chamber 2 due to the boiling due to the irradiation, and the gain of liquid in the condensate collection area 4 due to the subsequent collection of condensate therein. Due to the continuous flow back of condensate, i.e., liquid to the liquid target in the boiling chamber 2, the liquid target may not boil to dryness, and overheating is prevented.

In this example, the irradiation of the liquid target 8 results in the production of Ac-225, by the photonuclear reaction Ra-226 (γ,n) Ra-225 (β-) Ac-225. It is preferred that any Ac-225 formed may be separated from the liquid target 8. In this example, the liquid target system comprises an opening 22 in a bottom of the boiling chamber 2, functioning as an inlet and/or outlet for the liquid target 8, e.g., before and after, but preferentially not during, the irradiation. Thereby, the liquid target 8 may, after irradiation, be moved through the opening 22 to, e.g., a hot cell facility for chemical separation and purification of Ac-225. After said separation, the liquid target may be moved back through said opening 22 into the boiling chamber 2. To avoid crystallization and losses in any fluidic path, e.g., tubing, interconnecting the boiling chamber 2 and the hot cell facility, preferentially a certain rinsing volume of liquid, e.g. diluted nitric acid, is used directly after transferring the liquid target 8 through said fluidic path. This may further dilute the basic chemicals in the liquid target 8 and thus reduce yields, that is, by the excess volume introduced by the rinsing volume. Said excess volume may be removed by boiling, in the boiling chamber 2, the liquid target 8 while establishing a flow of an inert gas, e.g., helium or N₂, from opening 22 to opening 31, thereby removing any excess vapor. However, by appropriate design of the target (ratio of the volume of the boiling chamber 2 to the volume of the condensate chambers 4), this excess volume may not be a problem. Indeed, the volume ratio between liquid in the boiling room 2, i.e., irradiated by the beam, and liquid in the condensate collection chambers 4 may be optimized, and the concentration of Ra in the boiling chamber may be increased. For example, in the case of a 1/1 volume ratio, the concentration of Ra in the beam may be doubled in operation, i.e., during irradiation of the liquid target 8, compared to a design not comprising the condensate collection chambers 4. As a result, the production yields will also double. It is an advantage of this up-concentration that a low amount of parent nuclide, e.g., Ra-226, may be needed for the gamma production route to obtain a high isotope yield of Ra-225. This increased concentration may, during the irradiation, not be a problem with respect to a maximum in radium solubility, as the liquid target may be strongly heated, e.g., to 100° C. that is the boiling temperature of water at standard pressure or even above 100° C. when the pressure is above standard pressure, such that the solubility may be further increased.

In this example, the at least part of the liquid target system 10, i.e., the boiling chamber 2, the condensation area 3, and condensate collection areas 4, form a cylindrical shape, so as to limit the amount of welds, and which increases the strength of this part of the liquid target system that may operate at elevated pressures. Said higher pressure may be used to increase the boiling point of the water, and may influence the thermodynamics of the evaporation process. Indeed, when operating this liquid target 8 in the beam, any generated heat should be evacuated in a way that steady-state operation is safe and reliable. A boiling liquid target 8 is preferred, as it is an efficient and convenient way to remove the excess heat from a solution, i.e., the liquid target 8. Due to the relative small size of the liquid target 8, pressurizing may be strongly preferred to control the bubble size in the boiling liquid target 8. The higher the pressure, the smaller may be the bubbles and the better may be the boiling performance. Pressure and steady-state temperature may be controlled for optimizing the thermohydraulic performance of the liquid target 8.

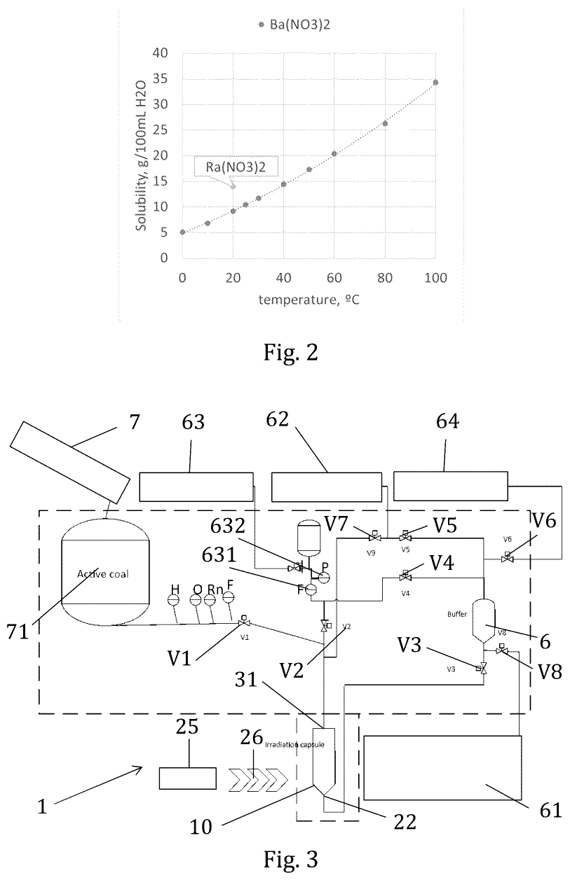

(Ra-226)(NO₃)₂ is well-suited for use in embodiments of the present invention, as it has a relatively high solubility in water compared to other Ra-226 salts. The compound is soluble for 13.9 g/100 g water at 20° C. and standard pressure (see Erbacher, O. Löslichkeits-Bestimmungen einiger Radiumsaltze; Berichte der deutschen chemischen Gesellschaft, 1930; Vol. 63:141-156). However, also other compounds, e.g., (Ra-226)Cl₂, may be used instead. Solubility of (Ra-226) (NO₃)₂ increases significantly at higher temperatures. To approximate the solubility of (Ra-226) (NO₃)₂ at elevated temperatures, the solubility of barium nitrate can be taken as a good approximation, due to very similar behaviour of alkaline earth metals Ra and Ba or Group 2 atoms (although the solubility of Ba(NO₃)₂ is slightly lower than that of Ra(NO₃)₂). Reference is made to FIG. 2, which is a plot of the solubility, in grams of the salt per 100 mL of H₂O, as dependent on temperature, in degrees Celsius. Data are shown for Ba(NO₃)₂ (from http://periodic-table-of-elements.org/SOLUBILITY/barium_nitrate) that are the dark dots connected by the dotted curve, over a temperature range of from 0° C. to 100° C., and for Ra (NO₃)₂, for which we have only data at 20° C. It may be observed that at 100° C., the solubility of Ba (NO₃)₂ increases by a factor of 3 compared to its solubility at 20° C. As such, the solubility at 100° C. is expected to be around 3 times higher also for Ra(NO₃)₂. We expect even higher solubility above 100° C. Indeed, the boiling point of water may be increased, firstly by the presence of the salt dissolved therein, and secondly by an increase in pressure.

A pressure dependence of Ra(NO₃)₂ may also be derived by comparing with Ba(NO₃)₂. The water solubility of Ba(NO₃)₂ increases from 0.394 to 0.841±0.005 mol/kg (from 13.79 to 29.435± 0.175 g/100 g H₂O) when increasing the pressure from standard pressure up to 200 MPa. (B.R. Churagulov, S.L. Lyubimov, A.N. Baranov, A.A. Burukhin. Influence of Pressures up to 300 MPa on the Water Solubilities of Poorly Soluble Salts. September 1999. Russian Journal of Inorganic Chemistry 44(9):1489-1493). As such, it is not expected that elevated pressures in the boiling chamber may have a negative influence (decrease) on the solubility of Ra(NO₃)₂ in the water of the liquid target.

We now proceed with a quantitative example. With reference back to FIG. 1A and FIG. 1B, as one example, we may consider a liquid target 8 having a volume of 25 cm³, and it is not preferred to exceed solubility at room temperature, which is 13.9 g/100 g water. Indeed, the liquid target 8 should be pumped in an out of the boiling chamber 2, i.e., between the boiling chamber 2 and the hot cell facility, which is typically approximately at room temperature. A higher concentration may, thus, result in precipitation in the fluidic path connecting the boiling chamber 2 with the hot cell facility. As such, when at room temperature, the liquid target may only contain around 2 grams of Ra-226. The goal is however to have 6 grams of the basic chemicals in the boiling chamber 2, to increase efficiency and yield of the liquid target system. As such, instead, a 6 gram Ra-226 target dissolved in 125 ml may be envisioned, and a volume ratio between liquid in the boiling chamber 2 and the condensate collection chambers 4 that is equal to 1/4. As such, initially, 100 mL of the liquid target is present in the condensate collection chambers 4, and 25 mL is present in the boiling chamber 2. At the start of the irradiation, the Ra-226 is homogeneously divided among the compartments. When the boiling chamber 2 starts to boil under influence of said irradiation, due to the mechanism explained above, the Ra-226 from the condensate collection chambers 4 will flow towards the boiling chamber 2, and remain there during the course of the irradiation. As such, over the course of time, Ra-226 will become depleted in the condensate collection chambers 4, such that the condensate collection chambers 2 only comprise liquid, i.e., condensate 41. Furthermore, the boiling chamber 2, comprising 25 cm³ of the liquid target, contains all remaining Ra-226 (i.e., 6 grams minus what has reacted to form Ra-225 or Ac-225). That is, effectively only the boiling chamber 2 comprises liquid target 8. As the water is heated, e.g., to 80° C. or 100° C., the concentration of basic chemicals in the liquid target 8 is still below the solubility limit for Ra(NO₃)₂.

In addition to heating due to the irradiation, forced heating (not resulting from the irradiation) of the boiling chamber 2, until steady-state is achieved, may be performed. It is an advantage that a steady-state, therein thermodynamics are continuous and predictable, may be rapidly achieved. Furthermore, when cooling down the liquid target 8 after said irradiation, slow cool-down may be preferred to avoid any precipitation of the Ra(NO₃)₂. One of the ways to achieve this could be to submerge the cylinder or target container, and then at least the boiling chamber 2 and condensate collection areas 4, in a water bath operating at, e.g., 70-80° C. Alternatively, a purge gas, causing forced mixing, may be introduced, e.g., through opening 22 and leaving through further opening 31 located above the boiling chamber 2.

Reference is made to FIG. 3, which is a schematic view of a liquid target system 1 in accordance with embodiments of the present invention, which may comprise the at least part of the liquid target system 10 of FIG. 1A and FIG. 1B. The boiling chamber comprised in the at least part of the liquid target system 10 may be irradiated by an irradiation beam 26 originating from an irradiation beam generator 25. In this example, an opening 22 in a bottom of the boiling chamber may be coupled to a buffer vessel 6 via valve V3. Said buffer vessel 6 is coupled, via valve V8, to a hot cell facility 61. Said buffer vessel 6 is further connected, via valve V5, to an inlet for introducing demineralized water 62. Said inlet for introducing demineralized water 62 is further connected, via valve V7, to the further opening 31. In this example, compressed gas, e.g., N₂ or He, may be introduced, from a compressed gas source 63, e.g., a compressed gas cylinder, through the opening 22, via valve V4, buffer vessel 6, and valve V3, or through the further opening 31, through valve V2. Furthermore, a vacuum may be introduced, from a vacuum source 64, e.g., a pump, through the opening 22, via valve V6, buffer vessel 6 and valve V3, or alternatively through the further opening 31, through valves V6, V4, and V2. The further opening 31 may be coupled to a chimney 7, via a volume comprising active coal 71 or any other system for capturing radioactive non-condensable gasses.

In an initial state, all valves V1-8 are closed. The buffer vessel 6 may be, subsequently, filled with liquid target by opening valves V6 and V8, such that a vacuum pulls the liquid target from the hot cell facility 61.

Subsequently, the liquid target may be moved to the boiling chamber and the condensate collecting areas by opening valves V4, V3 and VI, for introducing a gas flow (e.g., He or N₂) through the buffer vessel 6 via the boiling chamber in the at least part of the liquid target system 10, then through the active coal 71, and to the chimney 7, thereby moving the liquid target from the buffer vessel 6 to the boiling chamber. The fluid connection connecting the boiling chamber with the buffer vessel 6 may be flushed with demineralized water from the inlet for introducing demineralized water 62, by first filling the buffer vessel 6 with demineralized water by only having valve V5 opened, then close V5, open valve V4, and open valve V3. Alternatively, flushing may be performed by opening valve V7. This may result in additional liquid in the boiling chamber, but in the present invention, this may not be a problem due to potential up-concentration of the basic chemicals in the boiling chamber. Furthermore, in the next step, excess liquid in the boiling chamber may be evaporated and removed from the boiling chamber by a gas flow from the compressed gas source 63, through the boiling chamber, to the chimney 7, thereby reducing the volume of liquid in the boiling chamber.

In the next step, valve VI is opened, and the liquid target in the boiling chamber is boiled by using a low power irradiation beam 26 originating from the irradiation beam generator 25. Then irradiating, no valves, or, alternatively, possible only valves V4 and V3 may be opened, and VI slightly opened, so as to introduce compressed gas (e.g., Ar, He or N₂) in the at least part of the liquid target system 10, and so as to obtain a preferred, e.g., high, pressure in the at least part of the liquid target system 10. The flow may be controlled via flow controller 631 and pressure regulator 632. The increased pressure in the boiling chamber may enable the liquid in the boiling chamber to be at an increased temperature compared to atmospheric pressures, which may improve solubility of the basic chemicals. Furthermore, for example when the basic chemicals comprise Ra-226, a small gas flow may be retained so as to remove and collect any gases, e.g., Rn, formed in the boiling chamber. It is an advantage of embodiments of the present invention that the liquid target system is compatible with Rn collection.

After the photonuclear reaction in the boiling chamber, any radio-isotopes formed in the boiling chamber may be collected. For this, all valves may be closed, then valves V2 and V3 may be opened, to move, by a gas flow, the liquid target, comprising the radio-isotopes, from the boiling chamber to the buffer vessel 6. Possibly, afterwards, the tubing connecting the boiling chamber to the buffer vessel 6 may be flushed with demineralized water by opening valve V7. Finally, the buffer vessel 6 may be emptied to the hot cell facility 61, by closing all valves, then opening valves V8 and V4, followed by shortly opening valve V5 for flushing with demineralized water.

Although the at least part of the liquid target system 10 in the above explanation has been assumed to be the embodiment of the example relating to FIG. 1A and FIG. 1B, the at least part of the liquid target system 10 may instead be the embodiments of the subsequent example, or comprise features of both examples.

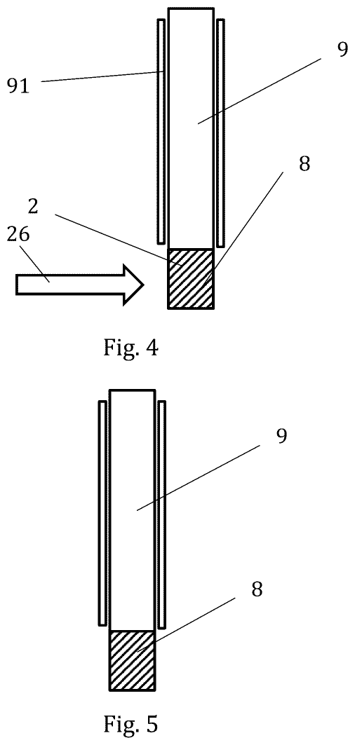

Reference is made to FIG. 4, which is a schematic representation of a further example of a liquid target system in accordance with embodiments of the present invention. The boiling chamber 2 comprises a liquid target 8, comprising the liquid and basic chemicals from which radio-isotopes can be produced. Irradiation 26 incident on the liquid target 8 results in heating of the liquid target 8, such that the liquid is evaporated to form vapor in a volume 9 above the boiling chamber 2. Walls of said volume thermally insulated by insulation material 91, so that a high temperature of the vapor in said volume may be achieved. Thereby, a higher concentration of the vapor in the volume may achieved, enabling pressure to build up. In other words, the volume 9 may comprise a large amount of the liquid in the vapor phase, i.e., the vapor. In embodiments, a ratio between a volume of the gas vapor in the volume 9 and a volume of the liquid target 8 in the boiling chamber 9 is at least 2, preferably at least 5.

In other words, aside from directly condensing the vapor that is formed, alternatively the volume above the boiling chamber thus can be used for storing the evaporated solvent as vapor.

Reference is made to FIG. 5. As a result of the evaporation due to the irradiation, and the large amount of vapor that is formed, the volume of the liquid target 8 is reduced. Thereby, the concentration of the basic chemicals therein is increased, which may increase the efficiency and yield of the nuclear reaction, e.g., a photonuclear reaction, of the basic chemicals to form the radio-isotopes. In embodiments, the irradiation is adapted for producing a pressure in the volume 9 that is up to 20 bar, e.g. up to 10 bar. The upper limit of the pressure is typically limited by the pressure that the walls of the liquid target system may withstand. The high pressure that is used may improve solubility of the basic chemicals in the liquid target 8 as it increases the boiling temperature, enabling, in turn, more liquid to evaporate without resulting in precipitation of the basic chemicals from the liquid target 8. During the irradiation of the liquid target 8, the concentration of basic chemicals in the liquid is preferably higher than a solubility of the basic chemicals in the liquid at room temperature, e.g., in absence of the irradiation. In this example, a high irradiation may thus result in a high yield both because of said high irradiation, and the up-concentration of basic chemicals in the liquid target 8. Overheating may, furthermore, be prevented by finding a balance between irradiation power and power loss due to evaporation of the liquid from the liquid target 8.

It is to be noted that in embodiments of the present invention, the operating conditions as well as additional measures can be selected so as to limit or prevent radiolysis, or reverse it by re-combination of oxygen with hydrogen. Such measures are known in the art. On example of a technical solution is given by https://link.springer.com/article/10.1007/BF02387473.

It is to be understood that although preferred embodiments, specific constructions and configurations, as well as materials, have been discussed herein for devices according to the present invention, various changes or modifications in form and detail may be made without departing from the scope of this invention. Steps may be added or deleted to methods described within the scope of the present invention.

1-14. (canceled).

15. A liquid target system for the production of radio-isotopes, the liquid target system comprising:
a boiling chamber containing, when in use, a liquid and basic chemicals from which the radio-isotopes can be produced using irradiation, the boiling chamber comprising an irradiation window for allowing the liquid and basic chemicals to be irradiated, causing the liquid to evaporate into vapor,
wherein the liquid target system is configured so that overheating of the liquid target is controlled by the thermodynamics of the evaporation process,
wherein the liquid is water or heavy water, and the basic chemicals are salts having a positive enthalpy for water.

16. The liquid target system according to claim 15, wherein the evaporated water is stored as steam or as liquid.

17. The liquid target system according to claim 15, the liquid target system further comprising:
a condensation area positioned above the boiling chamber, the condensation area having walls for condensing the vapor into liquid condensate,
wherein the liquid condensate can be systematically returned or provided to the boiling chamber.

18. The liquid target system according to claim 17, the liquid target system further comprising:
at least one condensate collecting area for collecting the liquid condensate, the at least one condensate collecting area being positioned outside the boiling chamber.

19. The liquid target system according to claim 18, wherein the at least one condensate collecting area and the boiling chamber are interconnected so as to act as communicating vessels.

20. The liquid target system according to claim 18, wherein the at least one condensate collecting area is positioned at the walls for condensing the vapor and is provided with a dripping mechanism for systematically returning the condensate to the boiling chamber.

21. The liquid target system according to claim 17, wherein the boiling chamber, the condensation area and the at least one condensate collecting area form a system having a cylindrical design.

22. The liquid target system according to claim 17, wherein the liquid target system further comprises a regulating fluid bath.

23. The liquid target system according to claim 17, wherein the liquid target system further comprises a regulating fluid circulation secondary system for insulating or controlling the temperature of the condensation area.

24. The liquid target system according to claim 22, wherein the outer wall of the boiling chamber, the condensation area and the at least one condensate collecting area is at least partly surrounded by the coolant fluid bath.

25. The liquid target system according to claim 23, wherein the outer wall of the boiling chamber, the condensation area and the at least one condensate collecting area is at least partly surrounded by the coolant fluid circulation secondary system.

26. The liquid target system according to claim 15, the system further comprising an irradiation beam generator configured for irradiating the liquid and basic chemicals.

27. The liquid target system according to claim 15, wherein the system furthermore comprises a pressurizing unit for pressurizing the boiling chamber for controlling the bubble size and the boiling temperature of the liquid.

28. The liquid target system according to claim 27, wherein the system further comprises a pressure sensor for measuring the pressure in the boiling chamber.

29. The liquid target system according to claim 15, wherein the basic chemicals are any or a combination of Ra(NO3)2, RaC12, and RaBr2.

30. The liquid target system according to claim 15, wherein the liquid target system is adapted for producing Sc-47, Cu-67, Cs-131, Tb-155, or Ac-225.

31. A method for producing radio-isotopes, comprising:
irradiating a liquid target comprising a liquid and basic chemicals from which the radio-isotopes can be produced using irradiation, causing the liquid to evaporate into vapor,
wherein the thermodynamics of said evaporation process are used so as to control overheating of the liquid target,
wherein the liquid is water or heavy water, and the basic chemicals are salts having a positive enthalpy for water.

32. Use of the liquid target system according to claim 15. for producing radio-isotopes.
